(19) United States
(12) Patent Application Publication
(10) Pub. No.: US 2006/0002278 A1
(43) Pub. Date: Jan. 5, 2006

(54) Spherical aberration corrector, optical pickup unit, and optical disk unit

(76) Inventor: Tomofumi Kitazawa, Kanagawa (JP)

Correspondence Address: DICKSTEIN SHAPIRO MORIN & OSHINSKY LLP, 2101 L Street, NW, Washington, DC, 20037, US

(21) Appl. No.: 11/170,097

(22) Filed: Jun. 30, 2005

(30) Foreign Application Priority Data
Jul. 2, 2004 (JP) 2004-197055

(51) Int. Cl. G11B 7/00

(52) U.S. Cl. 369/112.01

(57) ABSTRACT

A spherical aberration corrector is disclosed that includes a drive part configured to drive an optical element provided in each of multiple optical paths so that the optical elements move in conjunction with each other. The spherical aberration corrector corrects spherical aberration by moving the position of each optical element.

### BACKGROUND OF THE INVENTION

1. Field of the Invention

The present invention relates generally to spherical aberration correctors, optical pickup units, and optical disk units, and more particularly to a spherical aberration corrector correcting, in support of multiple standards, spherical aberration resulting from the thickness of the surface resin layer of an optical disk, an optical pickup unit including such a spherical aberration corrector, and an optical disk unit including such an optical pickup unit.

2. Description of the Related Art

Conventionally, an optical pickup unit is known that includes multiple optical systems in order to support optical disks of different standards using different laser wavelengths and different objective lens numerical apertures. In such an optical pickup unit including multiple optical systems, spherical aberration correction corresponding to each type of optical disk is required if each type of optical disk has multiple recording layers.

Japanese Laid-Open Patent Application No. 2003-173547 discloses an optical pickup unit including lens switching means for switching spherical aberration correction lenses in accordance with a difference in optical disk standards. However, this optical pickup unit does not support the case where each of optical disks of different standards has multiple recording layers.

Japanese Laid-Open Patent Application No. 2002-334475 discloses a technique for controlling an axis offset in the case of moving a lens by supporting the lens with a folded spring. However, it is difficult to make the folded spring.

Japanese Laid-Open Patent Application No. 09-022539 discloses a technique concerning a method of placing spherical aberration correction means in and removing it from a common optical path in order to compatibly play back optical disks different in substrate thickness with a single optical pickup. However, this conventional technique also fails to support the case where each of the optical disks of different standards has multiple recording layers.

Japanese Patent No. 3223074 discloses a method that disposes a spherical aberration correction lens in an optical path and places it into and out of the optical path in an optical pickup unit including a beam shaping prism.

Japanese Laid-Open Patent Application No. 05-266511 discloses a beam expander as means for correcting spherical aberration, the beam expander being disposed after a beam shaping prism and adjusting the convergence angle and the divergence angle of light entering an objective lens by switching the distance between lenses. In this case, the divergence angle and the convergence angle of a light beam entering the objective lens are adjusted by changing the distance between lenses so as to prevent spherical aberration from occurring on a recording surface to be subjected to recording and reproduction.

In order to perform spherical aberration correction in correspondence to each type of optical disk in an optical pickup unit including multiple optical systems as described above, drive means for moving the optical components of each optical system is required. However, there is a disadvantage such that the optical pickup unit is increased in size if the drive means is provided individually for each optical system.

An increase in the size of the optical pickup unit itself leads to an increase in the size of the optical disk drive unit. Accordingly, it is desired to prevent an increase in size in the optical pickup unit including multiple optical systems.

### SUMMARY OF THE INVENTION

Accordingly, it is a general object of the present invention to provide an optical pickup unit in which the above-described disadvantage is eliminated.

A more specific object of the present invention is to provide a spherical aberration corrector correcting spherical aberration in support of multiple standards without an increase in size, the spherical aberration resulting from the thickness of the surface resin layer of an optical disk, and an optical pickup unit including such a spherical aberration corrector.

Another more specific object of the present invention is to provide an optical disk unit including such an optical pickup unit.

One or more of the above objects of the present invention are achieved by a spherical aberration corrector including a drive part configured to drive an optical element provided in each of a plurality of optical paths so that the optical elements move in conjunction with each other, wherein the spherical aberration corrector corrects spherical aberration by moving a position of each optical element.

According to one aspect of the present invention, optical elements provided in multiple optical paths, respectively, are driven in conjunction with each other by a drive part. This makes it possible to correct spherical aberration in multiple standards, and to reduce the number of components.

One or more of the above objects of the present invention are also achieved by a spherical aberration corrector including: laser light sources of different wavelengths; a light guiding part configured to guide light beams emitted from the laser light sources to a same optical path; a beam expander including a first lens and a second lens disposed so that the light guiding part is placed between the first and second lenses, the first lens being disposed in the same optical path, the second lens being disposed in each of optical paths of the light beams before being guided to the same optical path; and a drive part configured to drive the first lens disposed in the same optical path.

According to one aspect of the present invention, a part of the two lens groups of each beam expander is shared. As a result, it is possible to reduce a load on a driving force and to reduce the number of components.

One or more of the above objects of the present invention are also achieved by an optical pickup unit including a spherical aberration corrector according to the present invention.

According to one aspect of the present invention, the spherical aberration corrector of an optical pickup unit supporting multiple standards can be reduced in size. Accordingly, it is possible to prevent the optical pickup unit from increasing in size.

One or more of the above objects of the present invention are also achieved by an optical disk unit including an optical pickup unit including a spherical aberration corrector according to the present invention.

According to one aspect of the present invention, the spherical aberration corrector of an optical pickup unit supporting multiple standards can be reduced in size. Accordingly, it is possible to prevent an optical disk unit including such an optical pickup unit from increasing in size.

### BRIEF DESCRIPTION OF THE DRAWINGS

Other objects, features and advantages of the present invention will become more apparent from the following detailed description when read in conjunction with the accompanying drawings, in which:

FIG. 1 is a diagram showing the basic configuration of the optical elements of an optical system block in an optical pickup unit including multiple optical systems;

FIG. 2 is a diagram showing the basic configuration of the optical elements of an optical system block in another optical pickup unit including multiple optical systems;

FIG. 3 is a diagram showing a method of correcting spherical aberration in an optical pickup unit;

FIG. 4 is a diagram showing a configuration of the optical elements of the optical system block of an optical pickup unit according to a first embodiment of the present invention;

FIG. 5 is a diagram showing a method of correcting spherical aberration in an optical pickup unit;

FIGS. 6A and 6B are diagrams showing other configurations of the optical block of the optical pickup unit according to the first embodiment of the present invention;

FIGS. 7 and 8 are diagrams showing configurations of a lens fixing member according to the first embodiment of the present invention;

FIG. 9 is a diagram showing the basic configuration of the optical system block of an optical pickup unit;

FIG. 10 is a diagram showing a method of correcting spherical aberration in the optical pickup unit;

FIGS. 11 and 12 are diagrams showing a configuration of optical elements in the optical system block of an optical pickup unit according to a second embodiment of the present invention;

FIG. 13 is a diagram showing sliding of a spherical aberration correction lens frame according to the second embodiment of the present invention;

FIG. 14 is a diagram showing other sliding of the spherical aberration correction lens frame according to the second embodiment of the present invention;

FIGS. 15 and 16 are diagrams showing another configuration of the optical system block of the optical pickup unit according to the second embodiment of the present invention;

FIGS. 17 through 19 are diagrams showing a configuration of a lens frame for spherical aberration correction lenses applicable to the optical elements of the optical system block of an optical pickup unit according to a third embodiment of the present invention;

FIG. 20 is a diagram showing another configuration of the lens frame for spherical aberration correction lenses applicable to the optical elements of the optical system block of the optical pickup unit according to the third embodiment of the present invention;

FIG. 21 is a diagram showing a configuration of the optical system block of an optical pickup unit according to a fourth embodiment of the present invention;

FIG. 22 is a diagram showing a configuration of the optical system block of an optical pickup unit according to a sixth embodiment of the present invention;

FIG. 23 is a diagram showing a configuration of the optical system block of an optical pickup unit according to a seventh embodiment of the present invention;

FIGS. 24 and 25 are diagrams showing a configuration of a movable lens frame of an optical pickup unit according to an eighth embodiment of the present invention;

FIG. 26 is a diagram showing a configuration of a known movable lens frame;

FIG. 27 is a graph showing the relationship between the movement of a lens in an optical axis direction and the offset of the lens in its longitudinal direction;

FIG. 28 is a graph showing axis offsets for different lengths of a spring member;

FIG. 29 is a diagram showing a configuration of a movable lens frame of an optical pickup unit according to a ninth embodiment of the present invention;

FIG. 30 is a diagram showing a configuration of an optical pickup unit according to a tenth embodiment of the present invention; and

FIG. 31 is a block diagram showing a disk drive according to an 11^{th} embodiment of the present invention.

### DETAILED DESCRIPTION OF THE PREFERRED EMBODIMENTS

A description is given below, with reference to the accompanying drawings, of embodiments of the present invention. In the following embodiments, a description is given, taking as an example the case of applying a spherical aberration correction of the present invention to an optical pickup unit.

### First Embodiment

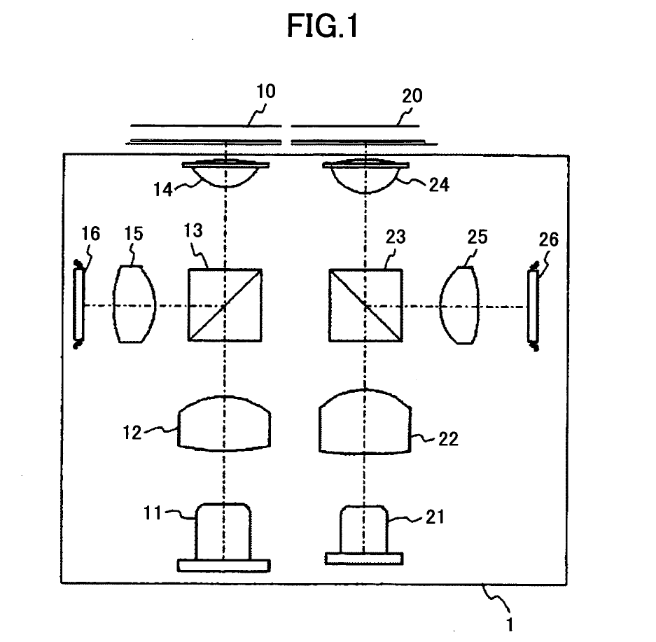

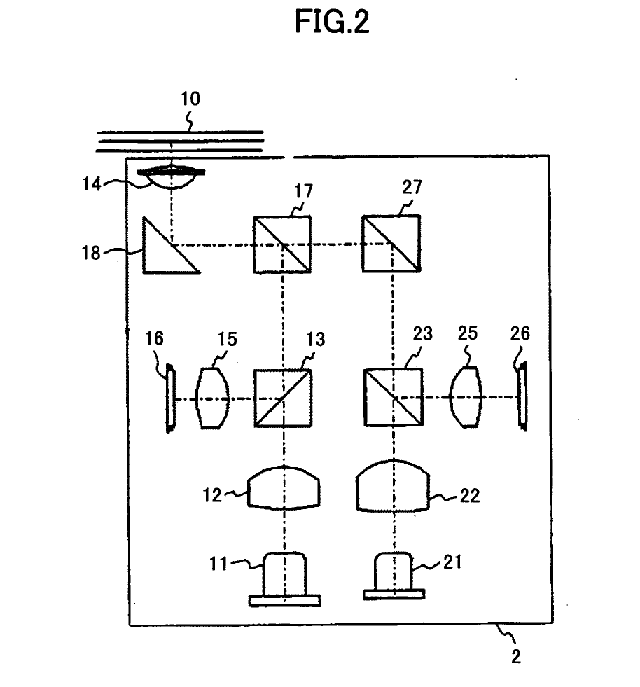

First, a description is given, with reference to FIGS. 1 through 8, of a structure of an optical pickup unit 30 according to a first embodiment of the present invention. Prior to this, a description is given, with reference to FIGS. 1 and 2, of basic configurations of the optical system block of an optical pickup unit including multiple optical systems.

FIG. 1 is a diagram showing the basic configuration of the optical elements of an optical system block in an optical pickup unit 1 including multiple optical systems.

In the optical pickup unit 1 shown in FIG. 1, laser light (beam) emitted from a laser diode 11 of one optical system passes through a coupling lens 12, a beam splitter 13, and an objective lens 14 to be focused into a spot on the recording surface of a disk 10. Reflected light from the recording surface of the disk 10 has its optical path changed by 90° in the beam splitter 13 so as to reach a photodetector 16 through a condenser lens 15.

Laser light (beam) emitted from a laser diode 21 of the other optical system passes through a coupling lens 22, a beam splitter 23, and an objective lens 24 to be focused into a spot on the recording surface of a disk 20. Reflected light from the recording surface of the disk 20 has its optical path changed by 90° in the beam splitter 23 so as to reach a photodetector 26 through a condenser lens 25. In this case, the laser diodes 11 and 21 emit respective laser beams of different wavelengths.

FIG. 2 is a diagram showing the basic configuration of the optical elements of an optical system block in an optical pickup unit 2 including multiple optical systems. In FIG. 2, the same elements as those of FIG. 1 are referred to by the same numerals, and a description thereof is omitted.

The optical pickup unit 2 shown in FIG. 2 is configured to share the objective lens 14 by merging two optical paths into a single optical path in the middle of the two optical paths.

In this case, laser light (beam) emitted from the laser diode 11 of one optical system passes through the coupling lens 12 and the beam splitter 13 to be reflected by a dichroic prism 17 and then deflected by a deflection mirror 18. Then, the laser light passes through the objective lens 14 to be focused into a spot on the recording surface of the disk 10. Reflected light from the recording surface of the disk 10 travels via the deflection mirror 18 and the dichroic prism 17 to the beam splitter 13. The reflected light has its optical path changed by 90° in the beam splitter 13 so as to reach the photodetector 16 through the condenser lens 15.

Laser light (beam) emitted from the laser diode 21 of the other optical system passes through the coupling lens 22 and the beam splitter 23 to be reflected by a prism 27. Then, the laser light passes through the dichroic prism 17 and then is deflected by the deflection mirror 18 so as to be focused into a spot on the recording surface of a disk 20 through the objective lens 14. Reflected light from the recording surface of the disk 10 travels via the deflection mirror 18, the dichroic prism 17, and the prism 27 to the beam splitter 23. The reflected light has its optical path changed by 90° in the beam splitter 23 so as to reach the photodetector 26 through the condenser lens 25. In the optical pickup units 1 and 2 configured as shown in FIGS. 1 and 2, respectively, a spherical aberration correction part to correct spherical aberration is required if the disk has multiple recording layers or the disk includes a spherical aberration more than or equal to an allowable value.

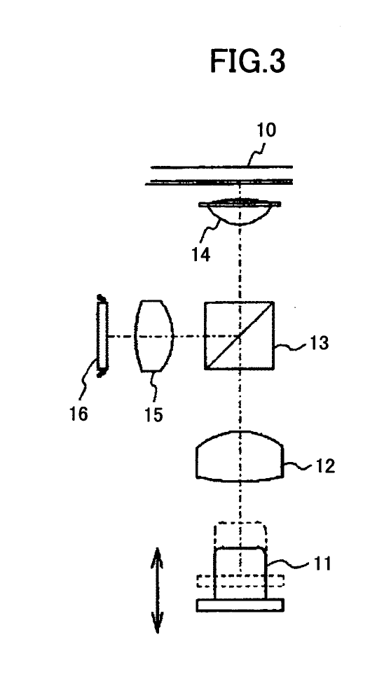

FIG. 3 is a diagram showing a method of correcting spherical aberration in an optical pickup unit. According to the spherical aberration correction method shown in FIG. 3, the divergence angle and the convergence angle of a light beam entering the objective lens 14 are adjusted by moving the laser diode 11 in the optical axis directions (directions indicated by the double-headed arrow), thereby preventing spherical aberration from being caused on the target recording surface.

In the case of applying the spherical aberration correction method shown in FIG. 3 to the optical pickup units 1 and 2 shown in FIGS. 1 and 2, respectively, a drive part to drive a laser diode is required for each of the laser diodes 11 and 12, thus increasing the size of the optical pickup units 11 and 12.

Accordingly, in the first embodiment of the present invention, the optical pickup unit may be configured as follows.

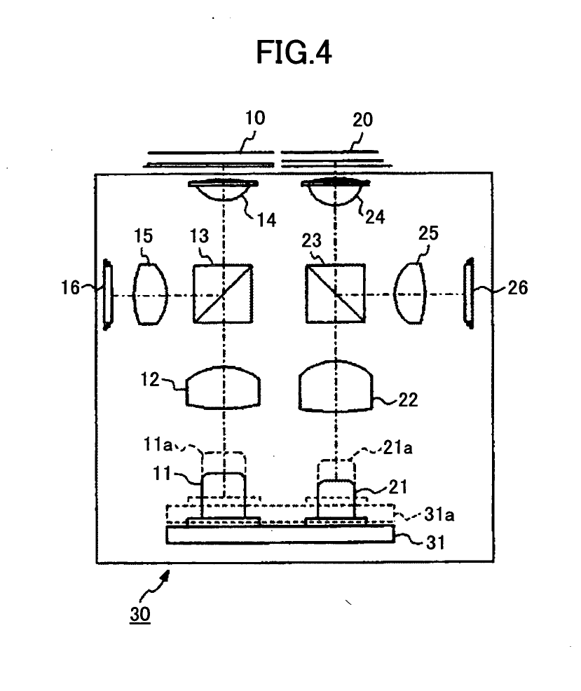

FIG. 4 is a diagram showing a configuration of the optical elements of the optical system block of an optical pickup unit 30 according to the first embodiment of the present invention. In FIG. 4, the same elements as those of FIG. 1 are referred to by the same numerals, and a description thereof is omitted.

As shown in FIG. 4, in the optical pickup unit 30 according to the first embodiment, the two laser diodes 11 and 21 are fixed by a diode fixing member 31, and the diode fixing member 31 is driven by a single drive part. That is, the laser diodes 11 and 21 are moved (forward and backward) along the optical axis directions by the single drive part, so that these two laser diodes 11 and 21 are moved together, that is, in conjunction with each other. In other words, in this case, the laser diodes 11 and 21 are moved together to a position where it is possible to properly correct the aberration of one of two optical systems provided in the optical pickup unit 30 which one is being used for recording or reproduction. For instance, in the case of FIG. 4, the diode fixing member 31 may be driven as indicated by 31a, so that the laser diodes 11 and 21 are moved as indicated by 11a and 21a. Accordingly, this configuration reduces two drive parts conventionally required for the laser diodes 11 and 21, respectively, to the single drive part. Accordingly, it is possible to prevent an increase in the size of an optical pickup unit by reducing the number of components of the optical pickup unit.

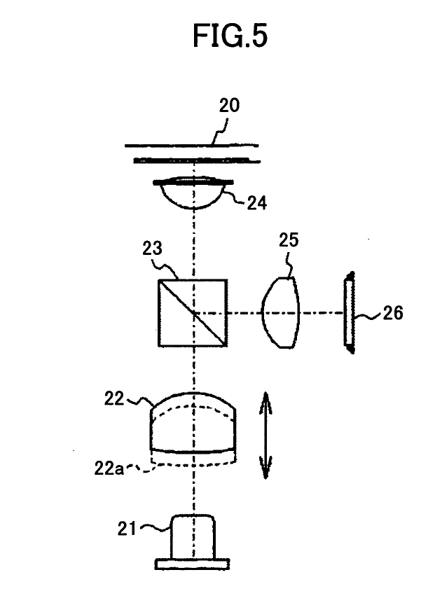

As a method of correcting spherical aberration in the optical pickup unit, a method shown in FIG. 5 is also known, where spherical aberration is corrected by moving the coupling lens 22 in the optical axis directions (indicated by the double-headed arrow). For instance, in the case of FIG. 5, the coupling lens 22 may be moved as indicated by 22a. In this case, the optical pickup unit also increases in size as in the spherical aberration correction method shown in FIG. 3 because a drive part to drive a coupling lens is required for each of the coupling lenses 12 and 22.

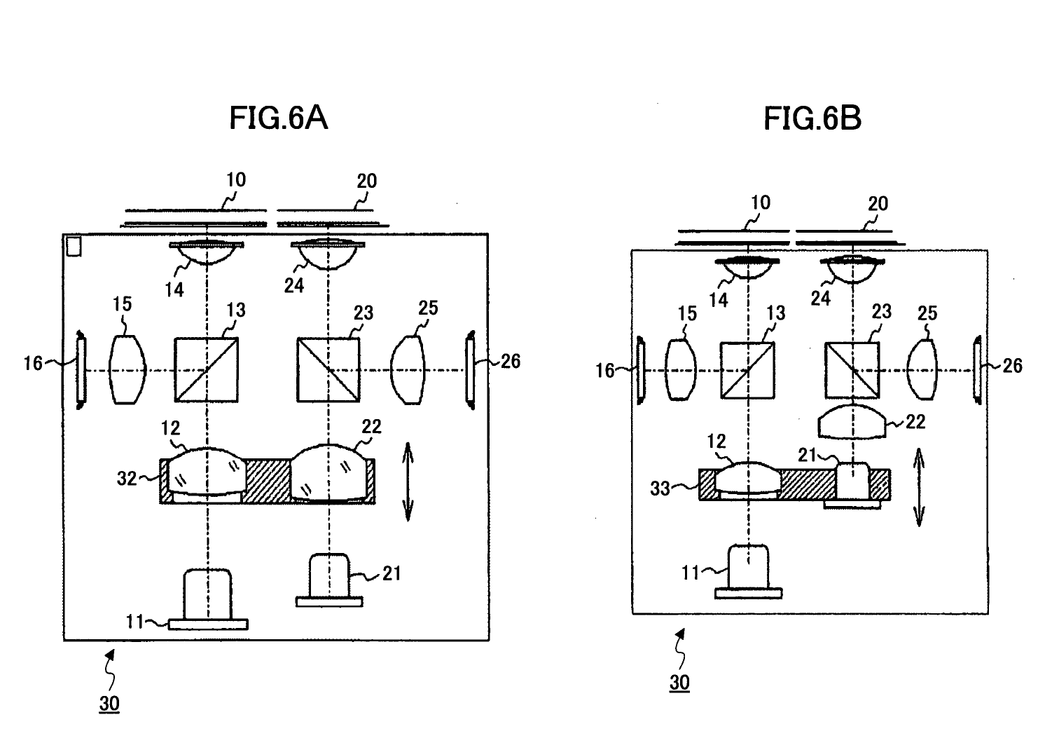

Accordingly, in this embodiment, the optical pickup unit may be configured as follows. FIGS. 6A and 6B are diagrams showing other configurations of the optical block of the optical pickup unit 30 according to the first embodiment.

According to the configuration shown in FIG. 6A, the two coupling lenses 12 and 22 are fixed by a single coupling lens fixing member 32, and the coupling lens fixing member 32 is driven by a single drive part. This configuration also makes it possible to reduce the number of components, thus preventing the optical pickup unit 30 from increasing in size, because two drive parts conventionally required for the coupling lenses 12 and 22, respectively, are reduced to the single drive part.

According to the configuration shown in FIG. 6B, the coupling lens 12 of one optical system and the laser diode 21 of the other optical system are fixed by a fixing member 33. This configuration also includes only a single drive part. Accordingly, the number of components can be reduced, so that it is possible to prevent the optical pickup unit 30 from increasing in size.

The laser diodes or coupling lenses of the two optical systems of an optical pickup unit can be fixed with a fixing member and driven by a single drive part. This is because when information reading or recording is performed in one of the optical systems, information reading or recording is not performed in the other optical system, so that the position of the laser diode or coupling lens of the optical system in which no information reading or recording is being performed does not matter.

There is no particular limitation to the drive part to drive each of the fixing members 31 through 33. For instance, a motor, a plunger, etc., may be employed as the drive part.

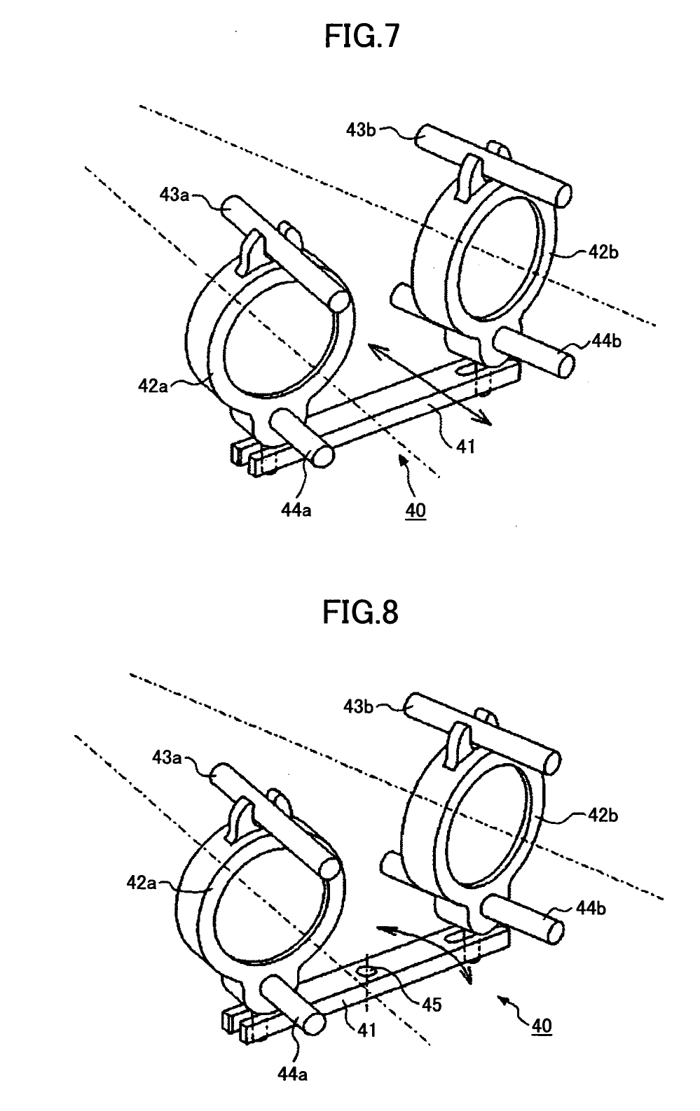

FIGS. 7 and 8 are diagrams showing a lens fixing member 40 as an example of the above-described fixing members 31 through 33. The lens fixing member 40 includes a transmission member 41 and two lens frames 42a and 42b attached thereon. Guide poles 43a and 44a are provided on top and at the bottom, respectively, of the lens frame 42a. Guide poles 43b and 44b are provided on top and at the bottom, respectively, of the lens frame 42b. When the optical axes of light beams passing through the lens frames 42a and 42b, respectively, are not parallel as shown in FIG. 7, the transmission member 41 is moved forward or backward along the optical axis directions (directions indicated by the double-headed arrow). Meanwhile, as shown in FIG. 8, a support part 45 may be provided in the center of the transmission member 41 so that the direction of the optical axis may be changed to a rectilinear direction by turning the transmission member 41 with the support part 45 serving as a supporting point.

In FIGS. 7 and 8, the lens fixing member 40 that moves lenses is shown as a fixing member. The same applies to the case of moving laser diodes by fixing the laser diodes with a fixing member.

Further, in the first embodiment, a description is given of the case where the optical system block of the optical pickup unit 1 shown in FIG. 1 is employed. Alternatively, it is also possible to realize an optical pickup unit according to the first embodiment using the optical system block of the optical pickup unit 2 configured as shown in FIG. 2.

Further, in the first embodiment, a description is given of the case where two optical systems are provided in an optical pickup unit so as to support optical disks of two different standards. Alternatively, three or more optical systems may be driven by a single drive part in order to support three or more standards.

### Second Embodiment

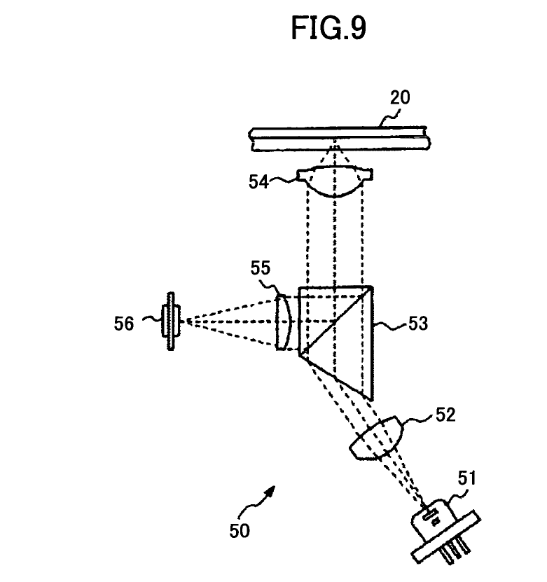

Next, a description is given, with reference to FIGS. 9 through 16, of a structure of an optical pickup unit according to a second embodiment of the present invention. First, a description is given, with reference to FIG. 9, of the basic configuration of the optical elements of an optical system block to be applied to the optical pickup unit of this embodiment.

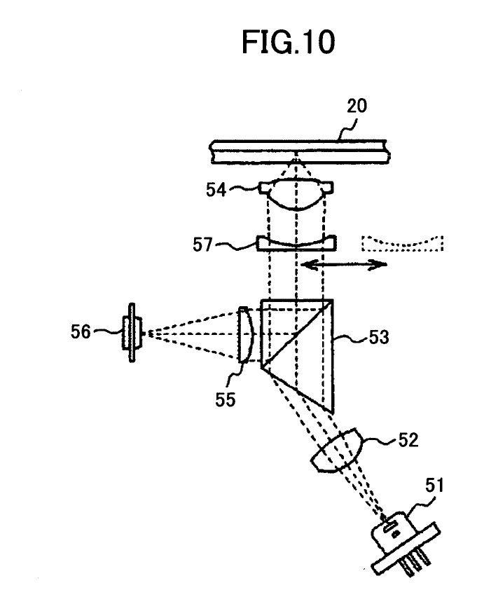

An optical pickup unit 50 shown in FIG. 9 includes a laser diode 51 emitting laser light (beam) a collimator lens 52, a beam shaping prism (beam splitter) 53, an objective lens 54, a condenser lens 55, and a photodetector 56. Beam shaping is performed by the beam shaping prism 53. In the optical system block thus configured, a light beam entering the beam shaping prism 53 should be a parallel beam. Accordingly, it is impossible to correct spherical aberration by displacing the laser diode 51 or the collimator lens 52. Therefore, in an optical pickup unit of such a configuration, a spherical aberration correction lens 57 correcting spherical aberration is disposed in a parallel beam path and is placed into and out of the optical path as shown in FIG. 10, which method is disclosed in Japanese Patent No. 3223074 as described above.

However, in the case of configuring an optical pickup unit including multiple optical systems in order to support optical disks of multiple standards using the optical system of the optical pickup unit as shown in FIG. 10, a drive part is required for each optical system in order to place its spherical aberration correction lens 57 into and out of its optical path. Accordingly, the optical pickup unit increases in size.

Accordingly, in the second embodiment of the present invention, the optical pickup unit may be configured as follows.

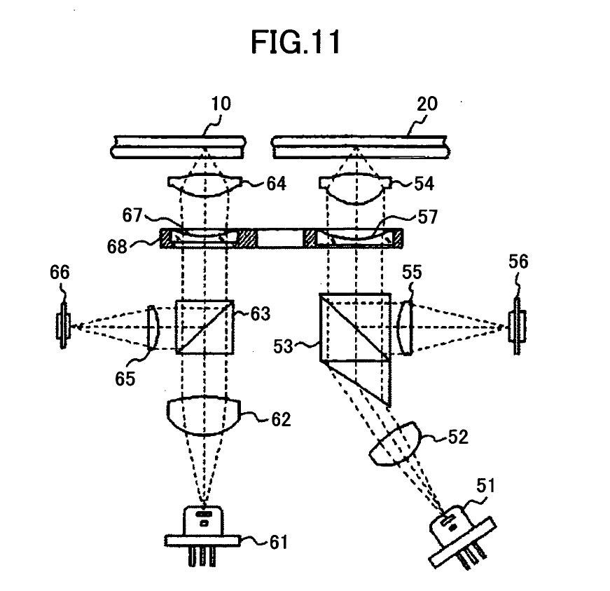

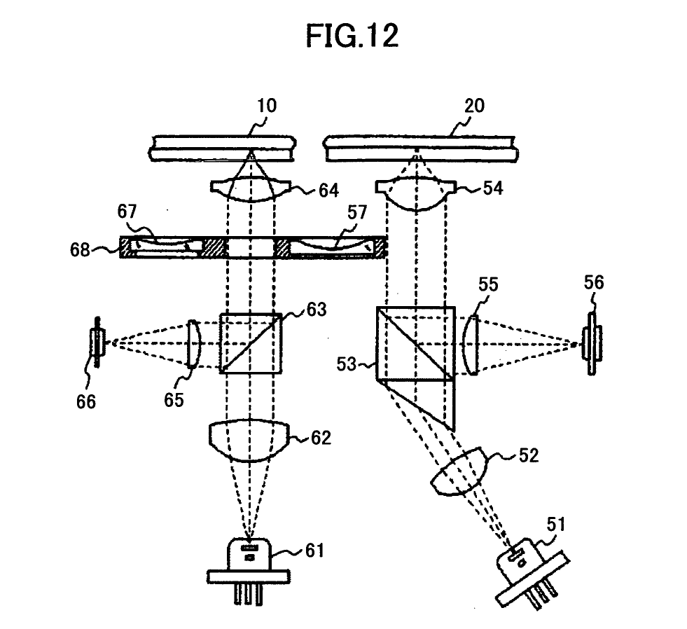

FIGS. 11 and 12 are diagrams showing a configuration of optical elements in the optical system block of an optical pickup unit according to the second embodiment of the present invention. In FIGS. 11 and 12, the same elements as those of FIGS. 9 and 10 are referred to by the same numerals, and a description thereof is omitted.

Referring to FIG. 11, in the optical pickup unit according to the second embodiment, laser light (beam) emitted from a laser diode 61 of one optical system passes through a collimator lens 62, a beam splitter 63, a spherical aberration correction lens 67, and an objective lens 64 to be focused into a spot on the recording surface of the disk 10. Reflected light from the recording surface of the disk 10 has its optical path changed by 90° in the beam splitter 63 so as to reach a photodetector 66 through a condenser lens 65.

Laser light (beam) emitted from the laser diode 51 of the other optical system passes through the collimator lens 52, the beam shaping prism (splitter) 53, a spherical aberration correction lens 57, and the objective lens 54 to be focused into a spot on the recording surface of the disk 20. Reflected light from the recording surface of the disk 20 has its optical path changed by 90° in the beam splitter 53 so as to reach the photodetector 56 through the condenser lens 55. The laser diodes 51 and 61 emit laser beams of different wavelengths also in this case.

According to this embodiment, the two spherical aberration correction lenses 67 and 57 are held by a single lens frame (lens holding part) 68 for spherical aberration correction lenses. This lens frame 68 is driven by a single drive part so as to move in directions perpendicular to the optical path of each optical system as shown in FIGS. 11 and 12. Thereby, each of the spherical aberration correction lenses 67 and 57 is placed into and out of the corresponding optical path.

This configuration has only a single drive part. Accordingly, the number of components can be reduced, so that it is possible to prevent the optical pickup unit from increasing in size.

Further, also in this case, while information reading or recording is performed in one optical system, no information reading or recording is performed in the other optical system. Accordingly, in the optical system that is not in use, the presence or absence of the corresponding spherical aberration correction lens 67 or 57 does not matter.

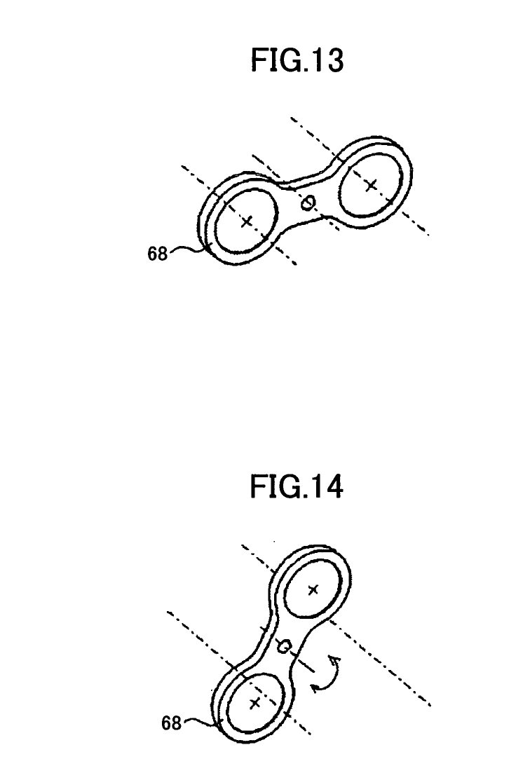

Further, in the optical pickup unit shown in FIGS. 11 and 12, the lens frame 68 to which the spherical aberration correction lenses 67 and 57 are fixed is caused to slide in directions perpendicular to the optical axis, so that each of the spherical aberration correction lenses 67 and 57 is placed into and out of the corresponding optical path. Alternatively, for instance, each of the spherical aberration correction lenses 67 and 57 may be placed into and out of the corresponding optical path by rotating the lens frame 68 about a common rotation axis as shown in FIGS. 13 and 14.

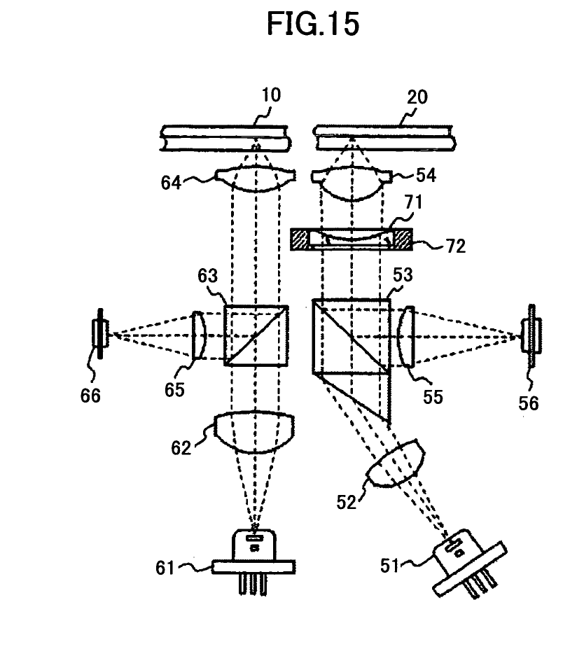

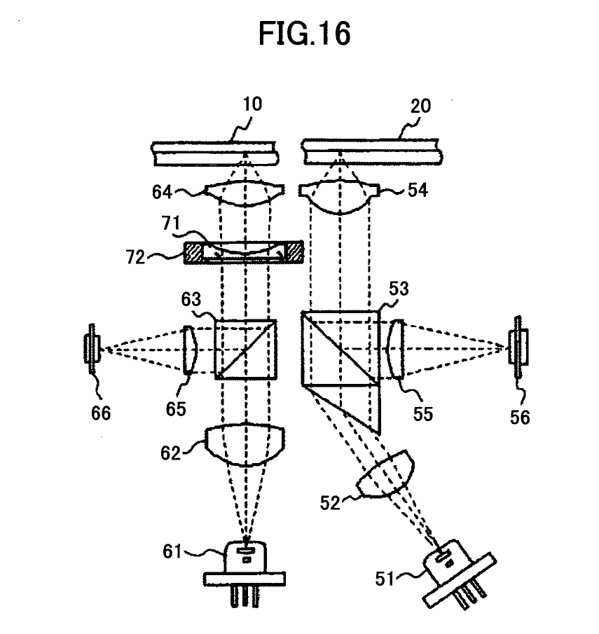

FIGS. 15 and 16 are diagrams showing another configuration of the optical system block of the optical pickup unit according to the second embodiment. As shown in FIGS. 15 and 16, a single spherical aberration correction lens 71 is held by a single lens frame (lens holding part) 72 for spherical aberration correction lenses. It is possible to use each other's optical path as a space to escape to by driving the lens frame 72 with a drive part. In this case, it is possible to reduce the required space.

According to the second embodiment, it is possible to share placement and displacement of a correction lens for switching between the recording layers of optical disks of different standards to be subjected to reading and writing.

### Third Embodiment

In the optical pickup units shown in FIGS. 9 through 16, a single spherical aberration lens is placed into and out of each optical path in accordance with the standard of each disk. In this case, however, switching is limited to between two stages.

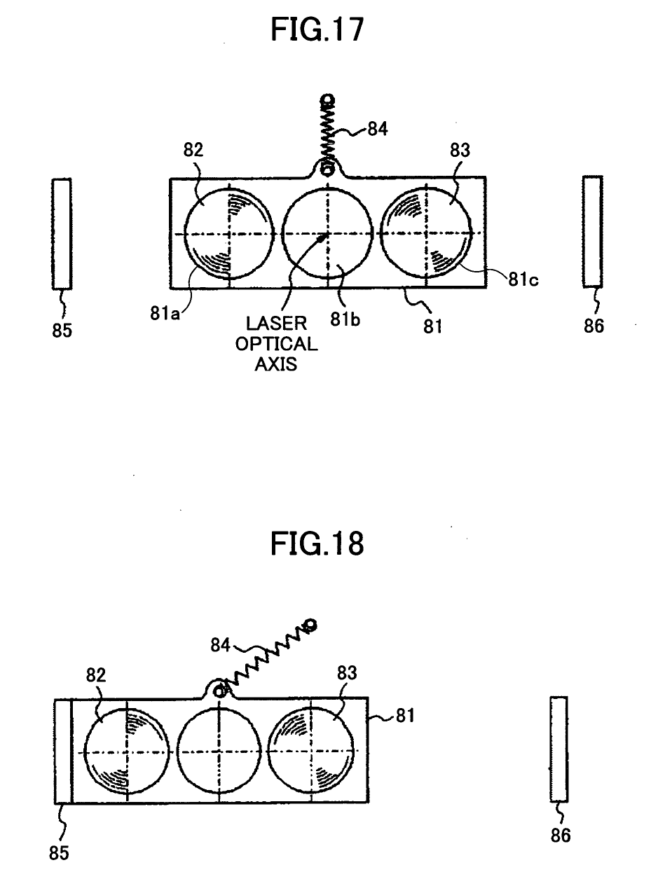

Accordingly, a description is given, with reference to FIGS. 17 through 20, of configurations of a lens frame for spherical aberration correction lenses applicable to the optical elements of the optical system block of an optical pickup unit according to a third embodiment of the present invention.

In this case, a lens frame 81 for spherical aberration correction lenses having three holes 81a, 81b, and 81c as shown in FIG. 17 is prepared. Spherical aberration correction lenses 82 and 83 are attached to the lens hole 81a on the left side and the lens hole 81c on the right side, respectively. No lens is attached to the hole 81b in the center. A tension spring 84 is attached to the intermediate position of the lens frame 81. Further, stoppers 85 and 86 are provided on both sides of the lens frame 81. In this lens frame 81, the intermediate position between the stoppers 85 and 86 (a neutral position) matches the optical axis of laser light.

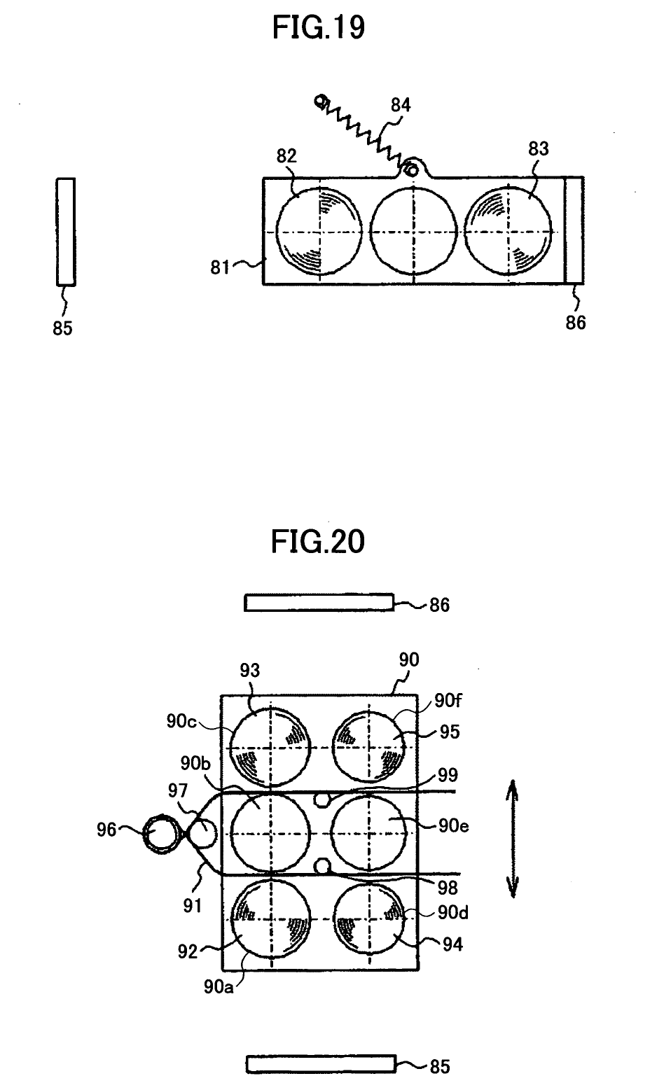

According to this configuration, when the lens frame 81 is pulled by an electromagnetic part to be in contact with the stopper 85 as shown in FIG. 18, the spherical aberration correction lens 83 is placed into the optical axis (optical path) of laser light. On the other hand, when the lens frame 81 is pulled by the electromagnetic part to be in contact with the stopper 86 as shown in FIG. 19, the spherical aberration correction lens 82 is placed into the optical axis of laser light. Accordingly, by thus configuring the lens frame 81 for spherical aberration correction lenses, it is possible to perform switching among three stages of the two lenses 82 and 83 and no lens. Further, when the lens frame 81 is in the position where the spherical aberration correction lens 82 or 83 is placed into the optical path of laser light, the lens frame 81 is pulled to be pressed and held against the stopper 86 or 85. Accordingly, it is possible to retain each of the spherical aberration correction lenses 82 and 83 in a correct lens position.

When the lens frame 81 is in the center position (neutral position), the lens frame 81 is held in the center position by the tension spring 84. However, it is difficult to completely stabilize the lens frame 81 in this state. However, no lens is attached to the hole 81b provided in the center of the lens frame 81. Accordingly, even if the lens frame 81 is offset to some extent, the lens frame 81 can be held without being affected substantially by the offset if the offset is not so much as to block a light beam.

Next, a description is given, with reference to FIG. 20, of another configuration of the lens frame for spherical aberration correction lenses applicable to the optical elements of the optical system block of the optical pickup unit according to the third embodiment. In FIG. 20, the same elements as those of FIG. 19 are referred to by the same numerals, and a description thereof is omitted.

A lens frame 90 shown in FIG. 20 is configured so that spherical aberration correction can be performed among three stages with respect to each of two optical systems using multiple spherical aberration lenses for each optical system. A torsion coil spring 91 is used instead of the tension spring 84 as the intermediate (neutral) position retaining part of the lens frame 90. In this case, spherical aberration correction lenses 92, 93, 94, and 95 are attached to four lens holes 90a, 90c, 90d, and 90f, respectively, provided in both end parts of the lens frame 90, and no lens is attached to each of two center holes 90b and 90e. Projections 96 through 99 are provided in order to hold the coil spring of the torsion coil spring 91.

According to this configuration, when the lens frame 90 comes into contact with the stopper 85, each of the spherical aberration correction lenses 93 and 95 is placed into the corresponding optical axis (optical path) of laser light. On the other hand, when the lens frame 90 comes into contact with the stopper 86, each of the spherical aberration correction lenses 92 and 94 is placed into the corresponding optical axis of laser light. Accordingly, it is possible to perform three-stage switching in the case of including two optical systems.

According to the third embodiment, spherical aberration correction lenses of two types are placed into and out of an optical path by a drive part moving a correction lens frame in a direction perpendicular to a laser optical axis, so that three-stage spherical aberration correction can be performed. Accordingly, it is possible to perform three-stage spherical aberration correction with a simple drive part.

### Fourth Embodiment

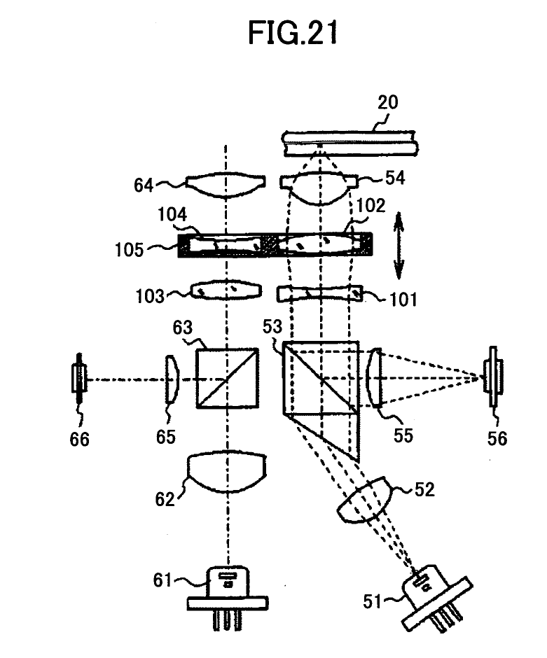

Next, a description is given, with reference to FIG. 21, of a structure of an optical pickup unit according to a fourth embodiment of the present invention. In FIG. 21, the same elements as those of FIG. 11 are referred to by the same numerals, and a description thereof is omitted.

As described above, Japanese Laid-Open Patent Application No. 05-266511 discloses a beam expander as means for correcting spherical aberration, the beam expander being disposed after a beam shaping prism and adjusting the convergence angle and the divergence angle of light entering an objective lens by switching the distance between lenses. In this case, the divergence angle and the convergence angle of a light beam entering the objective lens are adjusted by changing the distance between lenses so as to prevent spherical aberration from occurring on a recording surface to be subjected to recording and reproduction.

In this case, however, if an optical pickup unit including multiple optical systems in order to support disks of multiple standards is formed, the optical pickup unit also increases in size because a drive part to drive the position of a lens of the beam expander is required for each optical system.

Accordingly, in the optical pickup unit according to the fourth embodiment of the present invention, of lenses 101 and 102 of a beam expander provided in one optical system and lenses 103 and 104 of a beam expander provided in the other optical system, the lenses 102 and 104 are housed in a movable lens frame 105 to be integrated, so that the two lenses 102 and 104 are moved simultaneously along the directions of an optical axis (directions indicated by the double-headed arrow) with a single drive part.

Thus, according to this configuration, when information reading or recording is performed in an optical system, the lens position is adjusted for the optical system since no information reading or recording is performed in the other optical system. Accordingly, it is possible to adjust the two optical systems with the single drive part. This makes it possible to reduce the number of components of the optical pickup unit, so that it is possible to prevent the optical pickup unit from increasing in size. If the optical paths of the optical systems are not parallel, each of the lenses 102 and 104 may be moved through a transmission member as shown in FIG. 7 or 8.

According to the fourth embodiment, a beam expander is provided in each optical path as an optical element, and spherical aberration correction is performed by a drive part driving the movable lenses of the expanders in conjunction with each other. Accordingly, a spherical aberration corrector can be formed in a beam shaping system. Further, since the movable lenses are guided so as to move in an optical axis direction, there is an advantage in that an axis offset is less likely to occur.

### Fifth Embodiment

Next, a description is given of a structure of an optical pickup unit according to a fifth embodiment of the present invention.

In the optical pickup unit shown in FIG. 21, the position of a movable part may be changed in a multistage manner using a motor, so that the lens distance may be set individually for each beam expander. However, a large space is required in order to provide the motor and a deceleration part.

Therefore, if the numerical aperture (NA) of an objective lens is not so high, or if it is possible to reduce variations in substrate thickness, it may be possible to control spherical aberration to allowable values only by performing two-stage switching (of spherical aberration correction) with a plunger on an optical disk having two different recording layers.

Accordingly, if each of optical disks of different standards has multiple recording layers, the amount of driving of the lens of each expander may be set to the same value. Thereby, even if the optical disks have different standards, it is possible to prevent a spherical aberration more than specified from occurring in each recording layer with a simple two-stage-switching-type actuator. In this case, the glass material and the curvature of each component lens may be determined so that the movable lens of each beam expander is driven by the same amount.

According to the fifth embodiment, there is an advantage in that no complicated drive part is necessary for switching target recording layers.

### Sixth Embodiment

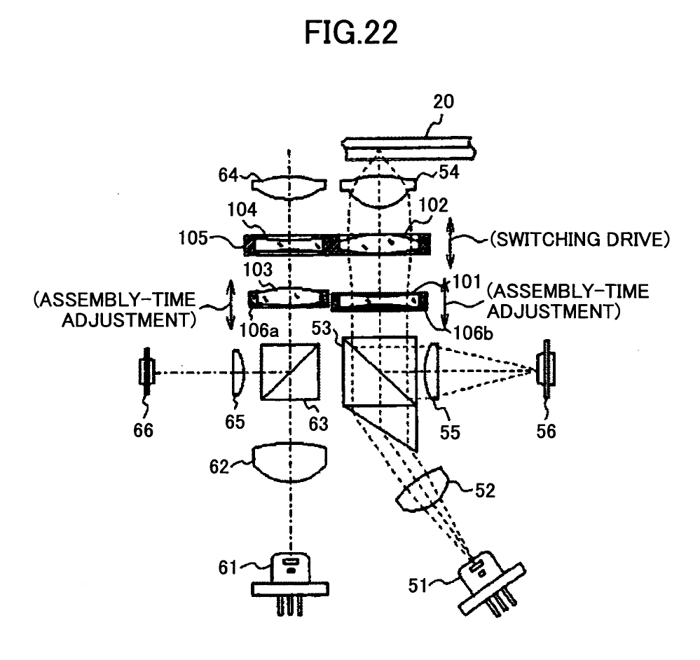

Next, a description is given, with reference to FIG. 22, of a structure of an optical pickup unit according to a sixth embodiment of the present invention. In FIG. 22, the same elements as those of FIG. 21 are referred to by the same numerals, and a description thereof is omitted.

In an optical pickup unit having a beam expander as shown in FIG. 21, an appropriate lens distance of the beam expander is subject to change because of variations in the wavelength of the laser diode 51 or 61 and components. Accordingly, it may be necessary to adjust the lens distance.

Accordingly, in this case, lens frames (a position adjustment part) 106a and 106b that can move the fixed lenses 101 and 103 of the expanders, respectively, in the optical axis directions (directions indicated by the double-headed arrows) are provided as shown in FIG. 22. The lens distance of one optical system can be adjusted without affecting the other optical system by moving the corresponding one of the lens frames 106a and 106b independently at the time of assembly.

### Seventh Embodiment

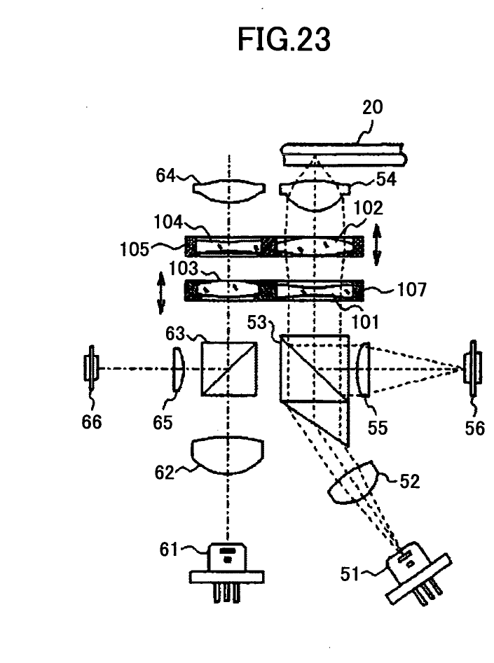

Next, a description is given, with reference to FIG. 23, of a structure of an optical pickup unit according to a seventh embodiment of the present invention. In FIG. 23, the same elements as those of FIG. 21 are referred to by the same numerals, and a description thereof is omitted.

In the above-described optical pickup unit shown in FIG. 21, with one of the lenses of each beam expander (101 or 103) being fixed, the other one of the lenses (102 or 104) is moved in the optical axis directions, thereby varying the lens distance of each beam expander. However, if the drive part is switchable between only two stages as in the case of a plunger, there are only two combinations of lens distances.

Accordingly, as shown in FIG. 23, of the lenses 101 through 104 of the beam expanders, the two front-side lenses 102 and 104 or a front-side lens group and the two rear-side lenses 101 and 103 or a rear-side lens group are housed in the movable lens frame 105 and a movable lens frame 107, respectively, and a drive part that can switch the lens frame between two stages is provided for each of the lens frames 105 and 107. Each of the front-side and rear-side lens groups is driven by the corresponding drive part.

According to this configuration, the lens distance of each beam expander can be adjusted with four stages of a, a+b, a+c, and a+b+c, where a is the lens distance at the stage of attachment when the lens distance is smallest (narrowest), b is the amount of driving of one of the lens frames 105 and 107, and c is the amount of driving of the other one of the lens frames 105 and 107.

### Eighth Embodiment

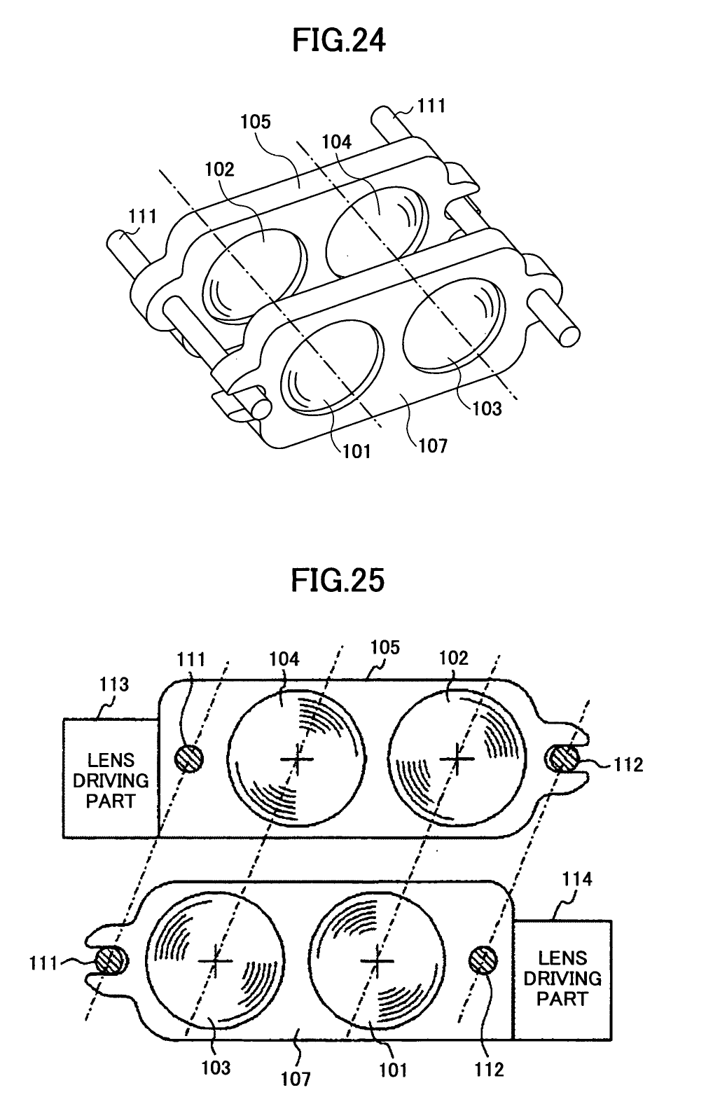

Next, a description is given, with reference to FIGS. 24 and 25, of a structure of an optical pickup unit according to an eighth embodiment of the present invention.

FIGS. 24 and 25 are diagrams showing a structure of the movable lens frames 105 and 107. As shown in FIG. 24, a main pole controlling the movement of lenses and a sub pole preventing rotation around the main pole in one of the lens frames 105 and 107 interchange their functions with each other in the other one of the lens frames 105 and 107. That is, a pole 111 serves as the main pole and a pole 112 serves as the sub pole in lens frame 105. On the other hand, the pole 111 serves as the sub pole and the pole 112 serves as the main pole in the lens frame 107.

As shown in FIG. 25, lens driving parts 113 and 114 for the lens frames 105 and 107 are disposed in the vicinity of their respective main poles 111 and 112. This facilitates disposition of the lens driving parts 113 and 114.

### Ninth Embodiment

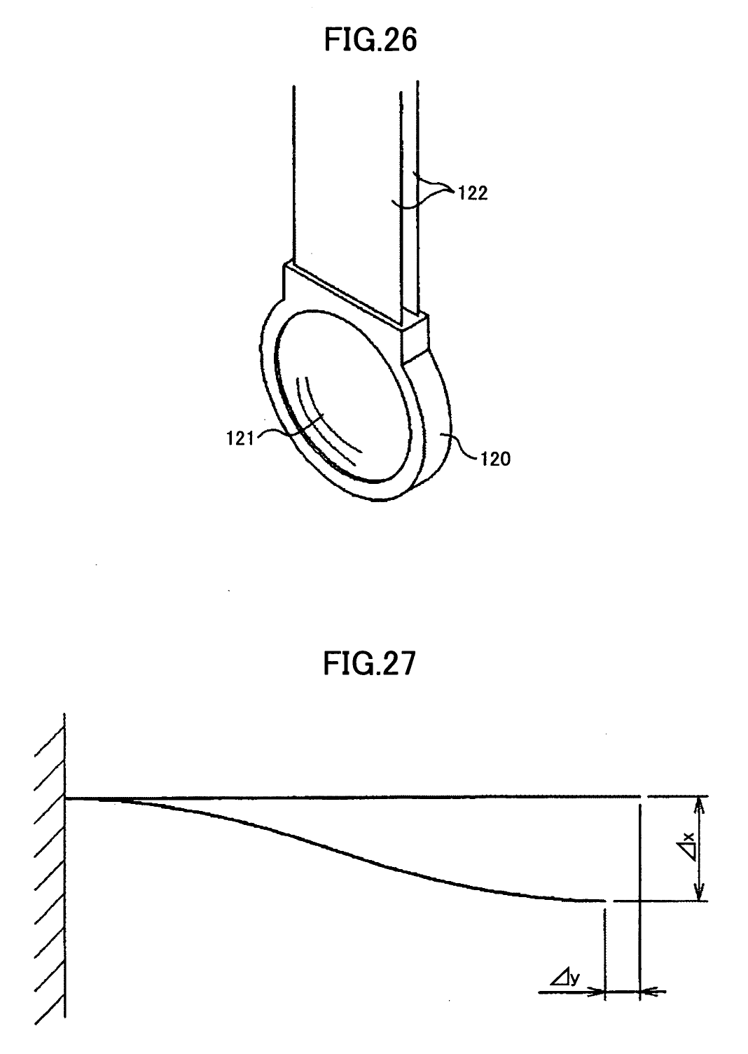

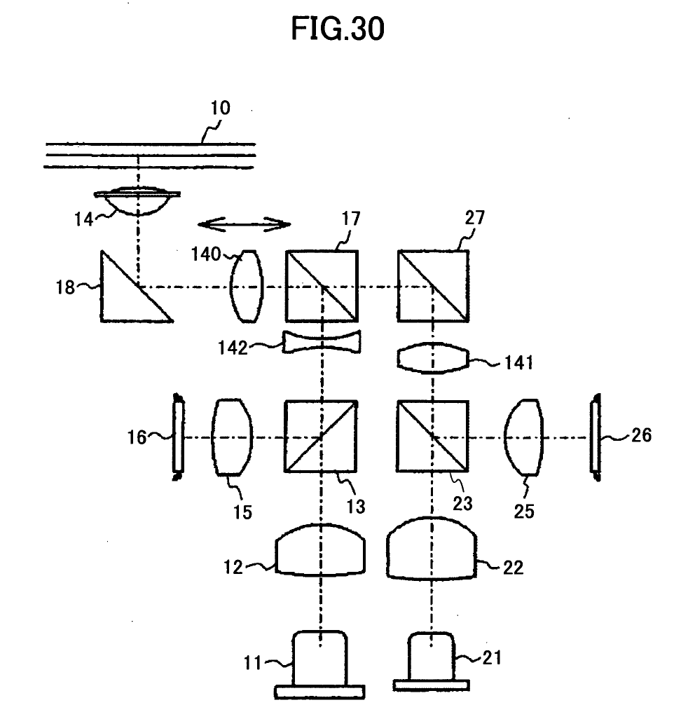

Next, a description is given, with reference to FIGS. 26 through 29, of a structure of an optical pickup unit according to a ninth embodiment of the present invention.

A method is known where a lens frame 120 of a lens 121 is held with a spring member 122 and is supported so that deflection of the spring member 122 allows a movable part to move as shown in FIG. 26.

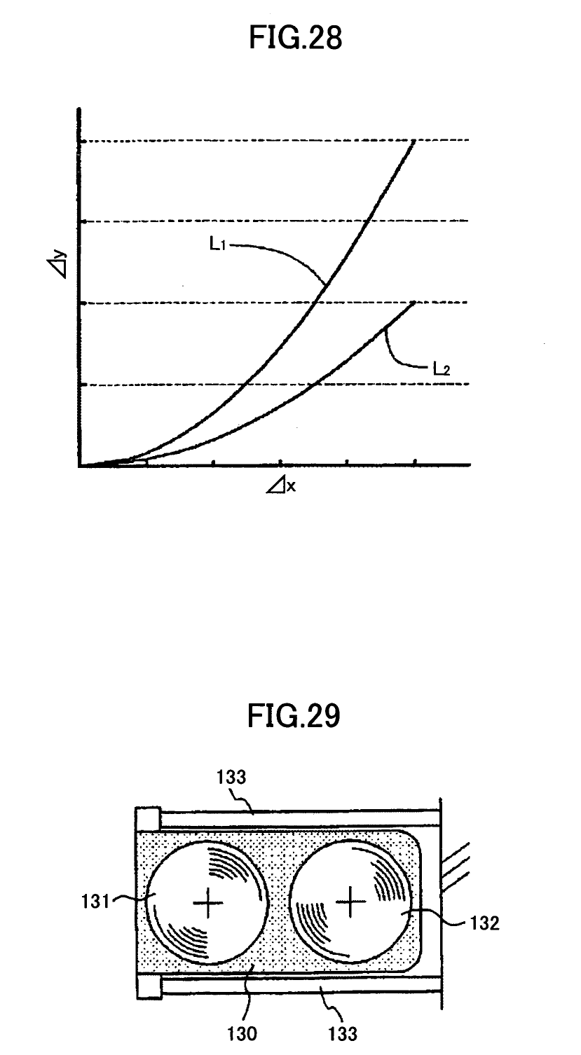

This configuration is advantageous in that it is possible to perform driving with a small force compared with supporting with poles as shown in FIG. 24 because there is no effect of friction of a sliding part. However, there is a defect in that when the lens frame 120 is moved in an optical axis direction (Δx), the lens 121 is offset in the longitudinal direction of the spring member 122 (Δy) as shown in FIG. 27. In order to reduce this effect, it is necessary that the spring member 122 have a great length for a movement in the optical axis direction. FIG. 28 shows axis offsets for different lengths L1 and L2 of the spring member 122. The length L2 is twice the length L1. If the amount of driving in the optical axis direction is the same, the axis offset is inversely proportional to the length of the spring member 122. However, if the spring member 122 is increased in length, the space for the spring member 122 should be increased accordingly.

Therefore, according to the ninth embodiment, the direction of arrangement of lenses 131 and 132 and the longitudinal direction of a spring 133 are aligned in a lens frame 130. This makes it possible to increase a spring member in length without wasting space. The spring 133 may be a leaf spring.

According to the ninth embodiment, in the case of supporting a lens frame holding lenses with a (leaf) spring member, the lenses may be arranged in the longitudinal direction of the spring member using an increase in the size of a movable part. As a result, it is possible to control an axis offset.

### Tenth Embodiment

Next, a description is given, with reference to FIG. 30, of a structure of an optical pickup unit according to a tenth embodiment of the present invention. In FIG. 30, the same elements as those of FIG. 2 are referred to by the same numerals, and a description thereof is omitted.

In the optical pickup unit shown in FIG. 30, the objective lens 14 is shared between disks of different standards by providing lenses 141 and 142 and a lens 140 before and after merger of optical paths, respectively, so that a beam expander is formed for each optical system, and moving the single common lens after merger of the optical paths. In this case, by adjusting the position of the lens 140 in the beam expander formed by the lenses 140 and 141 and the prism 27 provided therebetween, it is possible to guide a light beam emitted from the laser diode 21 and passing through the coupling lens 22 to the objective lens 14 with its convergence angle or divergence angle being controlled so that no spherical aberration is caused on the recording surface of the disk 10. Further, by adjusting the position of the lens 140 in the beam expander formed by the lenses 140 and 142 and the prism 17 provided therebetween, it is also possible to guide a light beam emitted from the laser diode 11 and passing through the coupling lens 12 to the objective lens 14 with its convergence angle or divergence angle being controlled so that no spherical aberration is caused on the recording surface of the disk 10. This configuration makes it possible to save space corresponding to the range of movement of a lens.

Accordingly, by providing an optical pickup unit including any of the spherical aberration correctors according to the above-described first through tenth embodiments in an optical disk drive, it is possible to prevent the optical disk drive from increasing in size because the optical pickup unit is prevented from increasing in size since a drive part for correcting spherical aberration can be shared between multiple optical systems.

According to the tenth embodiment, a part of the two lens groups of each beam expander is shared. As a result, it is possible to reduce a load on a driving force and to reduce the number of components.

### 11^{th} Embodiment

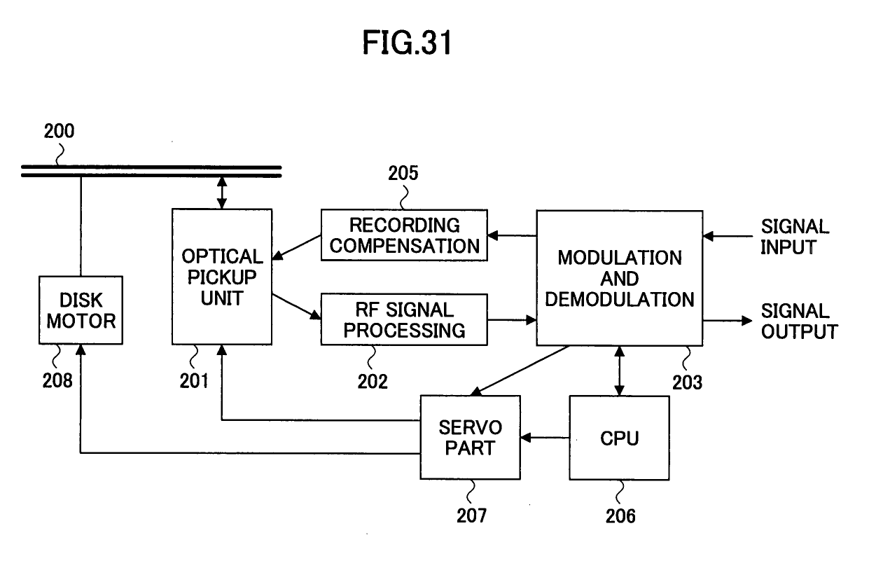

FIG. 31 is a basic block diagram showing a disk drive (disk unit) according to an 11^{th} embodiment of the present invention. The disk drive shown in FIG. 31 includes an optical pickup unit 201, an RF signal processing circuit 202, a modulation and demodulation circuit 203, a recording compensation circuit 205, a CPU 206, a servo part 207, and a disk motor 208. The disk drive shown in FIG. 31 is of a recording and reproduction type. Alternatively, the disk drive may be of a reproduction type omitting the recording compensation circuit 205.

An audio circuit, an image compression and decompression circuit, and/or an interface for connection to a computer are connected to a signal input and a signal output depending on the purpose of a signal. The recording compensation circuit 205 performs laser modulation with a recording signal. The RF signal processing circuit 202 includes a circuit shaping the waveform of a read signal. The servo part 207 detects error components such as a tracking error signal and a focus error signal from the read signal, and controls the optical pickup unit 201 including a spherical aberration corrector according to the present invention and the disk motor 208 by performing feedback. This servo part 207 performs focus servo, tracking servo, and pickup feed servo. A feed screw system, a rack pinion system, and a linear motor system are known as pickup feed mechanisms.

In reproducing information, an information signal recorded on an optical disk 200 is read out by the optical pickup unit 201, and the read-out signal is input to the RF signal processing circuit 202. The RF signal processing circuit 202 shapes the waveform of the input signal, and thereafter, inputs the signal to the modulation and demodulation circuit 203. The modulation and demodulation circuit 203 demodulates the input signal, and thereafter, outputs the signal to, for instance, a host computer (not graphically illustrated).

In recording information, when a signal to be recorded is input, the modulation and demodulation circuit 203 modulates the input signal into a signal that is easily recordable on the optical disk 200. Next, the modulated signal is input to the recording compensation circuit 205, where laser modulation is performed so that a laser driving current (signal) corresponding to the signal is supplied to the optical pickup unit 201. In general, a current supplied at the time of information recording is larger than a current supplied at the time of information reproduction. In the optical pickup unit 201, a semiconductor laser emits light based on the input signal, so that the laser light is emitted onto the recording surface of the optical disk 200 from the optical pickup unit 201, thereby recording information. During this operation, servo control is constantly performed. The CPU controls, for instance, the servo part 207 and the modulation and demodulation circuit 203.

The present invention is not limited to the specifically disclosed embodiments, and variations and modifications may be made without departing from the scope of the present invention.

The configurations of a spherical aberration corrector and an optical pickup unit according to the present invention may be, but are not limited to, those described in the above embodiments. Further, in the above-described embodiments, a spherical aberration corrector according to the present invention is applied to an optical pickup unit. Alternatively, a spherical aberration corrector according to the present invention is also applicable to apparatuses or devices other than the optical pickup unit.

The present application is based on Japanese Priority Patent Application No. 2004-197055, filed on Jul. 2, 2004, the entire contents of which are hereby incorporated by reference.

What is claimed is:

1. A spherical aberration corrector, comprising:
a drive part configured to drive an optical element provided in each of a plurality of optical paths so that the optical elements move in conjunction with each other,
wherein the spherical aberration corrector corrects spherical aberration by moving a position of each optical element.

2. The spherical aberration corrector as claimed in claim 1, wherein:
the optical elements are spherical aberration correction lenses; and
the spherical aberration correction lenses are placed into and out of the corresponding optical paths in conjunction with each other by the drive part.

3. The spherical aberration corrector as claimed in claim 2, further comprising:
a correction lens frame to which the spherical aberration correction lenses are attached; and
a retaining part configured to retain the correction lens frame in a neutral position,
wherein the spherical aberration lenses are of two different types; and
the spherical aberration lenses of the two different types are placed into and out of the corresponding optical paths in conjunction with each other by the drive part moving the correction lens frame in a direction perpendicular to a laser optical axis so that three-stage spherical aberration correction is performable.

4. The spherical aberration corrector as claimed in claim 1, further comprising:
a beam expander provided in each optical path as the optical element, the beam expander including a movable lens,
wherein the movable lenses are driven in conjunction with each other by the drive part.

5. The spherical aberration corrector as claimed in claim 4, wherein:
the movable lenses of the beam expanders are switchable between two stages; and
the movable lenses are moved by a same amount.

6. The spherical aberration corrector as claimed in claim 4, further comprising:
a position adjustment part,
wherein each beam expander further includes a non-driven lens prevented from being driven by the drive part; and
the position adjustment part adjusts a position of each non-driven lens individually by moving the non-driven lens in an optical axis direction.

7. The spherical aberration corrector as claimed in claim 4, wherein:
each beam expander further includes a lens paired with the movable lens;
the movable lens and the paired lens of each beam expander are driven independent of each other by the drive part;
the movable lenses of the beam expanders are driven in conjunction with each other by the drive part; and
the paired lenses of the beam expanders are driven in conjunction with each other by the drive part.

8. The spherical aberration corrector as claimed in claim 7, wherein:
each of two lens frames holding the movable lenses and the paired lenses, respectively, of the beam expanders is supported by a main pole guiding the lens frame in a driving direction and a sub pole preventing rotation around the main pole; and
positions at which the main pole and the sub pole are disposed differ between the lens frames.

9. The spherical aberration corrector as claimed in claim 4, wherein:
a lens frame holding the movable lenses is supported by a leaf spring member; and
the movable lenses are arranged in a longitudinal direction of the leaf spring member.

10. A spherical aberration corrector, comprising:
laser light sources of different wavelengths;
a light guiding part configured to guide light beams emitted from the laser light sources to a same optical path;
a beam expander including a first lens and a second lens disposed so that the light guiding part is placed between the first and second lenses, the first lens being disposed in the same optical path, the second lens being disposed in each of optical paths of the light beams before being guided to the same optical path; and
a drive part configured to drive the first lens disposed in the same optical path.

11. An optical pickup unit, comprising:
a spherical aberration corrector as set forth in claim 1.

12. The optical pickup unit as claimed in claim 11, wherein:
the optical elements are spherical aberration correction lenses; and
the spherical aberration correction lenses are placed into and out of the corresponding optical paths in conjunction with each other by the drive part.

13. The optical pickup unit as claimed in claim 12, wherein the spherical aberration corrector further comprises:
a correction lens frame to which the spherical aberration correction lenses are attached; and
a retaining part configured to retain the correction lens frame in a neutral position,
wherein the spherical aberration lenses are of two different types; and
the spherical aberration lenses of the two different types are placed into and out of the corresponding optical paths in conjunction with each other by the drive part moving the correction lens frame in a direction perpendicular to a laser optical axis so that three-stage spherical aberration correction is performable.

14. The optical pickup unit as claimed in claim 1, wherein the spherical aberration corrector further comprises:
a beam expander provided in each optical path as the optical element, the beam expander including a movable lens,
wherein the movable lenses are driven in conjunction with each other by the drive part.

15. The optical pickup unit as claimed in claim 14, wherein:
the movable lenses of the beam expanders are switchable between two stages; and
the movable lenses are moved by a same amount.

16. The optical pickup unit as claimed in claim 4, wherein the spherical aberration corrector further comprises:
a position adjustment part,
wherein each beam expander further includes a non-driven lens prevented from being driven by the drive part; and
the position adjustment part adjusts a position of each non-driven lens individually by moving the non-driven lens in an optical axis direction.

17. The optical pickup unit as claimed in claim 14, wherein:
each beam expander further includes a lens paired with the movable lens;
the movable lens and the paired lens of each beam expander are driven independent of each other by the drive part;
the movable lenses of the beam expanders are driven in conjunction with each other by the drive part; and
the paired lenses of the beam expanders are driven in conjunction with each other by the drive part.

18. The optical pickup unit as claimed in claim 17, wherein:
each of two lens frames holding the movable lenses and the paired lenses, respectively, of the beam expanders is supported by a main pole guiding the lens frame in a driving direction and a sub pole preventing rotation around the main pole; and
positions at which the main pole and the sub pole are disposed differ between the lens frames.

19. The optical pickup unit as claimed in claim 14, wherein:
a lens frame holding the movable lenses is supported by a leaf spring member; and
the movable lenses are arranged in a longitudinal direction of the leaf spring member.

20. An optical pickup unit, comprising:
a spherical aberration corrector as set forth in claim 10.

21. An optical disk unit, comprising:
an optical pickup unit including a spherical aberration corrector as set forth in claim 1.

22. An optical disk unit, comprising:
an optical pickup unit including a spherical aberration corrector as set forth in claim 10.
